(19) United States
(12) Patent Application Publication
(10) Pub. No.: US 2019/0196955 A1
(43) Pub. Date: Jun. 27, 2019

(54) SOLID STATE DRIVE AND ASSOCIATED COMPUTER SYSTEM

(71) Applicants: Lite-On Electronics (Guangzhou) Limited, GUANGZHOU (CN); LITE-ON TECHNOLOGY CORPORATION, Taipei (TW)

(72) Inventors: Sheng-Yu CHANG, Taipei (TW); Ping-Jie CHEN, Taipei (TW); Chien-Chih WENG, Taipei (TW)

(21) Appl. No.: 15/879,491

(22) Filed: Jan. 25, 2018

(30) Foreign Application Priority Data
Dec. 21, 2017 (CN) 201711396300.6

(51) Int. Cl. G06F 12/02; G06F 11/10; G06F 3/06

(52) U.S. Cl. CPC G06F 12/0246; G06F 12/0253; G06F 12/0292; G06F 2212/2022; G06F 3/064; G06F 3/0679; G06F 11/1044

(57) ABSTRACT

A solid state drive is connected with a host. The solid state drive includes a non-volatile memory and a first flash translation layer. The non-volatile memory includes a first storage zone and a second storage zone. The first storage zone includes a boot area. An operating system is stored in the boot area. The first flash translation layer receives a first command and a first logical block address from the host. The first flash translation layer converts the first logical block address into a first physical block address, and the solid state drive accesses the first storage zone according to the first physical block address. The solid state drive receives a second command and a second physical block address from the host, and the solid state drive accesses the second storage zone according to the second physical block address.

This application claims the benefit of People's Republic of China Patent Application No. 201711396300.6, filed Dec. 21, 2017, the subject matter of which is incorporated herein by reference.

### FIELD OF THE INVENTION

The present invention relates to a solid state drive (SSD) and an associated computer system, and more particularly to an open-channel solid state drive (OC SSD) and an associated computer system.

### BACKGROUND OF THE INVENTION

As is well known, solid state drives (SSD) such as SD cards are widely used in various electronic devices. Generally, a solid state drive comprises a controlling circuit and a non-volatile memory.

FIG. 1 is a schematic functional block diagram illustrating the architecture of a conventional computer system. As shown in FIG. 1, the computer system 100 comprises a host 110 and a solid state drive 120. The host 110 is connected with the solid state drive 120 through a bus 130. For example, the bus 130 is a USB bus, SATA bus, PCIe bus, M.2 bus, U.2 bus, or the like.

In the solid state drive 120, the storage zone 124 of the non-volatile memory further comprises a boot area 122. An operating system (OS) is stored in the boot area 122.

Please refer to FIG. 1. When the computer system 100 is booted, a basic input output system (BIOS) of the host 110 detects that the solid state drive 120 is connected with the host 110. Then, the operating system is loaded from the boot area 122 of the solid state drive 120 into the memory of the host 110 and used as a kernel 112. In addition, all drivers for the operating system are loaded from the storage zone 124 of the solid state drive 120 into the host 110.

For example, a Windows NVMe access driver 114 is also loaded into the memory of the host 110. As known, the Windows NVMe access driver 114 is developed by Microsoft Corporation. The Windows NVMe access driver 114 is used as a communication interface between the kernel 112 and the solid state drive 120.

For example, the operating system is Microsoft Windows 10 operating system. After the computer system 100 is booted, the kernel 112 is loaded into the memory of the host 110. Consequently, the computer system 100 is a Windows 10 computer system.

Moreover, the loaded Windows NVMe access driver 114 is used as the communication interface between the kernel 112 and the solid state drive 120. If the user intends to access the data from the solid state drive 120 during the operation of the computer system 100, the kernel 112 uses the Windows NVMe access driver 114 to access the solid state drive 120.

When the host 110 intends to write a data into the solid state drive 120, the Windows NVMe access driver 114 issues a write command and a corresponding logical block address to the solid state drive 120. Moreover, the logical block address is converted into a physical block address by a flash translation layer (FTL) 126 of the solid state drive 120 according to a mapping table. After an error correction code (ECC) encoding operation is performed on the write data, the encoded write data is written into the corresponding physical block address of the storage zone 124.

When the host 110 intends to read a data from the solid state drive 120, the Windows NVMe access driver 114 issues a read command and a corresponding logical block address to the solid state drive 120. Moreover, the logical block address is converted into a physical block address by the flash translation layer 126 of the solid state drive 120 according to the mapping table. After an error correction code (ECC) decoding operation is performed on the read data, the corrected read data is transmitted to the host 110.

Generally, the flash translation layer 126 is a firmware algorithm that is installed in the solid state drive 120 and executed by a controlling circuit (not shown) of the solid state drive 120. As mentioned above, the flash translation layer 126 is used for converting the logical block address into the physical block address, performing the ECC encoding operation and the ECC decoding operation. In addition, the flash translation layer 126 is capable of performing a garbage collection operation and a wear leveling operation on the storage zone 124 at the right time.

Since the flash translation layer 126 is included in the solid state drive 120, the process of converting the logical block address into the physical block address, the garbage collection operation and the wear leveling operation are performed in the solid state drive 120. In other words, the host 110 of the conventional computer system 100 is unable to request the solid state drive 120 to perform the garbage collection operation and the wear leveling operation directly.

As mentioned above, the manufacturer of the solid state drive 120 has to develop the firmware algorithm of the flash translation layer 126 and apply the flash translation layer 126 to the self-developed solid state drive 120. In other words, the firmware algorithm of the flash translation layer developed by the specified manufacturer cannot be applied to the solid state drives of other manufacturers.

Recently, CNEX Lab has developed an open-channel solid state drive (OC SSD). Generally, the open-channel solid state drive is applied to a Linux computer system.

In the Linux computer system, the open-channel solid state drive is not equipped with the flash translation layer. The firmware algorithm of the flash translation layer is executed by the host.

For writing a data into the open-channel solid state drive, the host issues the write command and the corresponding physical block address to the open-channel solid state drive. That is, it is not necessary to perform the address conversion in the open-channel solid state drive. The write data is directly stored into the corresponding physical block address of the storage zone.

Similarly, for reading a data from the open-channel solid state drive, the host issues the read command and the corresponding physical block address to the open-channel solid state drive. The read data is directly read from the corresponding physical block address of the storage zone and transmitted to the host.

However, since the existing open-channel solid state drive is not equipped with the flash translation layer, the existing open-channel solid state drive cannot be installed in the computer system with the Windows operating system. In other words, after the computer system is booted, the BIOS cannot detect whether the open-channel solid state drive is connected with the host. Moreover, it is impossible to use the open-channel solid state drive to load the operating system into the computer system.

### SUMMARY OF THE INVENTION

An embodiment of the present invention provides a solid state drive. The solid state drive is connected with a host. The solid state drive includes a non-volatile memory and a first flash translation layer. The non-volatile memory includes a first storage zone and a second storage zone. The first storage zone includes a boot area. An operating system is stored in the boot area. The first flash translation layer receives a first command and a first logical block address from the host. The first flash translation layer converts the first logical block address into a first physical block address, and the solid state drive accesses the first storage zone according to the first physical block address. The solid state drive receives a second command and a second physical block address from the host, and the solid state drive accesses the second storage zone according to the second physical block address.

Another embodiment of the present invention provides a computer system. The computer system includes a solid state drive and a host. The solid state drive includes a non-volatile memory and a first flash translation layer. The non-volatile memory includes a first storage zone and a second storage zone. The first storage zone includes a boot area. An operating system is stored in the boot area. When the computer system is booted, the operating system in the boot area and a Windows NVMe access driver and an open-channel solid state drive driver in the first storage zone are loaded into a memory of the host. After the first flash translation layer receives a first command and a first logical block address from the Windows NVMe access driver, the first flash translation layer converts the first logical block address into a first physical block address, so that the solid state drive accesses the first storage zone according to the first physical block address. After the solid state drive receives a second command and a second physical block address from the open-channel solid state drive driver, the solid state drive accesses the second storage zone according to the second physical block address.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating the architecture of a conventional computer system; and

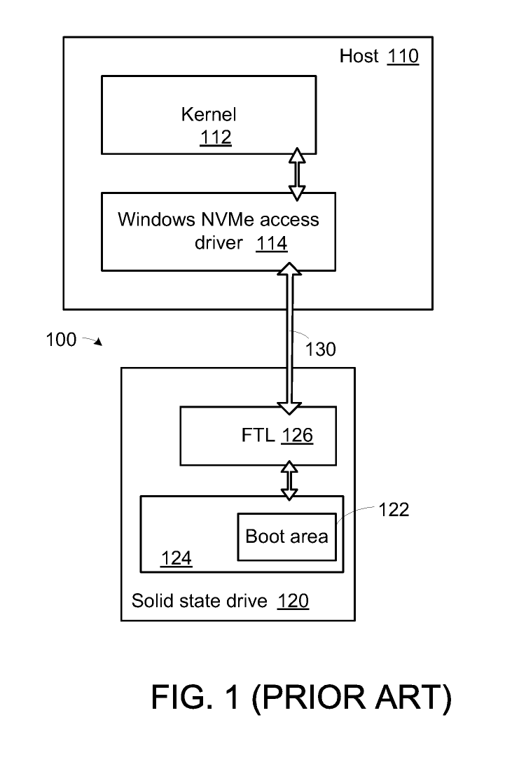

FIG. 2 is a schematic functional block diagram illustrating the architecture of a computer system according to an embodiment of the present invention.

### DETAILED DESCRIPTION OF PREFERRED EMBODIMENTS

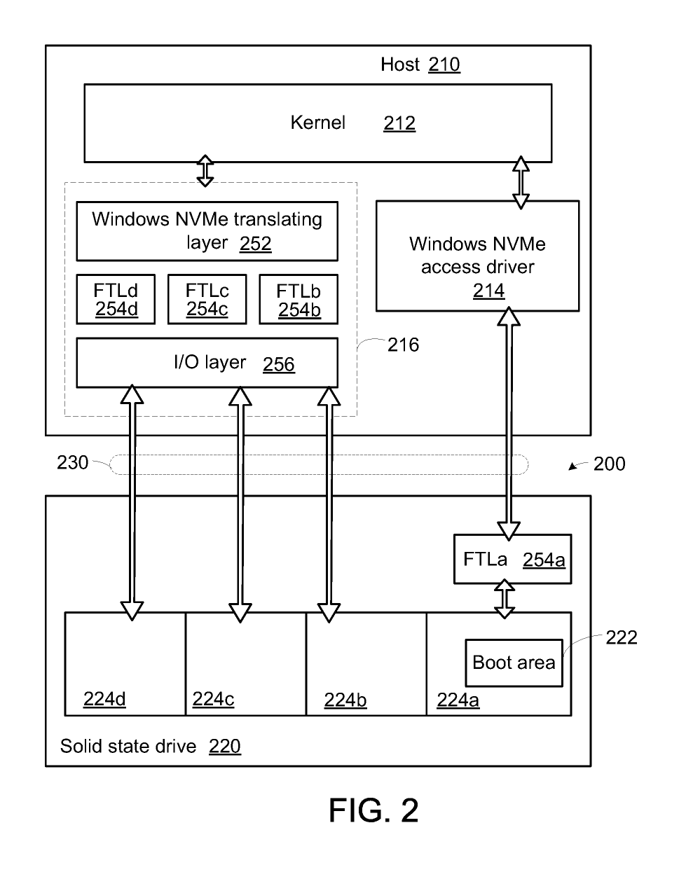

FIG. 2 is a schematic functional block diagram illustrating the architecture of a computer system according to an embodiment of the present invention. As shown in FIG. 2, the computer system 200 comprises a host 210 and a solid state drive 220. In this embodiment, the solid state drive 220 is an open-channel solid state drive with a boot function. The host 210 is connected with the solid state drive 220 through a bus 230. For example, the bus 230 is a USB bus, SATA bus, PCIe bus, M.2 bus, U.2 bus, or the like.

In an embodiment, the non-volatile memory of the solid state drive 220 comprises plural storage zones 224a, 224b, 224c and 224d. The storage zone 224a contains a boot area 222. An operating system (OS) is stored in the boot area 222.

For example, the storage capacity of the solid state drive 220 is 1T bytes. Moreover, the storage capacity of the four storage zones 224a, 224b, 224c and 224d is 256G bytes. The number of the storage zones in the non-volatile memory and the storage capacity of each storage zones are not restricted as long as the non-volatile memory comprises at least two storage zones.

Please refer to FIG. 2. When the computer system 200 is booted, a basic input output system (BIOS) of the host 210 can detect the storage zone 224a of the solid state drive 220 only. Then, the operating system (OS) is loaded from the boot area 222 of the solid state drive 220 into the memory of the host 210 and used as a kernel 212. In addition, all drivers for the operating system are loaded from the storage zone 224a of the solid state drive 220 into the host 210.

In this embodiment, a Windows NVMe access driver 214 and an open-channel SSD driver 216 are also loaded into the memory of the host 210. The Windows NVMe access driver 214 is used as a communication interface between the kernel 212 and the storage zone 224a of the solid state drive 220. Moreover, the open-channel SSD driver 216 is used as the communication interfaces between the kernel 212 and the other storage zones 224b, 224c and 224d of the solid state drive 220.

For example, the operating system is Microsoft Windows 10 operating system. After the computer system 200 is booted, the kernel 212 is loaded into the memory of the host 110. Consequently, the computer system 200 is a Windows 10 computer system.

Since the open-channel SSD driver 216 has been loaded into the host 210, the host 210 also detects the other storage zones 224b, 224c and 224d of the solid state drive 220. Moreover, the open-channel SSD driver 216 comprises a Windows NVMe translating layer 252, plural flash translation layers (FTL) 254b, 254c, 254d and an input/output (I/O) layer 256.

If the user intends to access the data from the storage zone 224a of the solid state drive 220 during the operation of the computer system 200, the kernel 212 uses the Windows NVMe access driver 214 to access the storage zone 224a of the solid state drive 220.

Moreover, if the user intends to access the data from the storage zone 224b, 224c or 224d of the solid state drive 220, the kernel 212 uses the open-channel SSD driver 216 to access the storage zone 224b, 224c or 224d of the solid state drive 220.

When the host 210 intends to write a data into the storage zone 224a of the solid state drive 220, the Windows NVMe access driver 214 issues a write command and a corresponding logical block address to the solid state drive 220. Moreover, the logical block address is converted into a physical block address by a flash translation layer (FTLa) 254a of the solid state drive 220. After an error correction code (ECC) encoding operation is performed on the write data, the encoded write data is written into the corresponding physical block address of the storage zone 224a.

When the host 210 intends to read a data from the storage zone 224a of the solid state drive 220, the Windows NVMe access driver 214 issues a read command and a corresponding logical block address to the solid state drive 220. Moreover, the logical block address is converted into a physical block address by the flash translation layer 254a of the solid state drive 220. After an error correction code (ECC) decoding operation is performed on the read data, the corrected read data is transmitted to the host 210.

As mentioned above, the function of the storage zone 224a of the solid state drive 220 has the function of the conventional solid state drive. Consequently, when the computer system 200 is booted, the operating system (OS) is loaded from the boot area 222 to the host 210. In addition, the flash translation layer 254a of the solid state drive 220 can perform the garbage collection operation and the wear leveling operation on the storage zone 224a.

Moreover, since the open-channel SSD driver 216 has been loaded into the host 210, the user can access the data from the storage zones 224b, 224c and 224d. A process of accessing the data of the storage zone 224b will be described as follows. The processes of accessing the data of the storage zones 224c and 224d are similar to the process of accessing the data of the storage zone 224b and will not be redundantly described herein.

When the host 210 intends to write a data into the storage zone 224b of the solid state drive 220, the kernel 212 issues a request to the Windows NVMe translating layer 252. In response to the request, the logical block address is converted into a physical block address by a flash translation layer (FTLb) 254b according to a mapping table. Then, an error correction code (ECC) encoding operation is performed on the write data. Then, the I/O layer 256 issues a write command and the physical block address to the solid state drive 220. Consequently, the encoded write data is written into the corresponding physical block address of the storage zone 224b.

When the host 210 intends to read a data from the storage zone 224b of the solid state drive 220, the kernel 212 issues a request to the Windows NVMe translating layer 252. In response to the request, the logical block address is converted into a physical block address by the flash translation layer (FTLb) 254b according to the mapping table. Then, the I/O layer 256 issues a read command and the physical block address to the solid state drive 220. After the data stored in the physical block address of the storage zone 224b is acquired, the data is transmitted to the I/O layer 256. After the flash translation layer (FTLb) 254b performs an error correction code (ECC) decoding operation on the read data, the corrected read data is obtained.

From the above description, the solid state drive 220 of the present invention has the function of the open-channel solid state drive. When the host 210 accesses each of the storage zones 224b, 224c and 224d of the solid state drive 220, the solid state drive 220 receives the command and the physical block address directly. Moreover, the solid state drive 220 does not perform the block address conversion, and the write data is directly stored in the storage zones 224b, 224c and 224d of the solid state drive 220. Alternatively, the read data are directly acquired from the physical block addresses of the storage zones 224b, 224c and 224d and transmitted to the host 210.

As mentioned above, the flash translation layers FTLb 254b, FTLc 254c and FTLd 254d are included in the open-channel SSD driver 216. Consequently, the host 210 can perform a garbage collection operation and a wear leveling operation on the storage zones 224b, 224c and 224d of the solid state drive 220.

Moreover, since the open-channel SSD driver 216 is installed in the host 210 by the user, the user can select the flash translation layers FTLb, FTLc and FTLd having different firmware algorithms in order to manage the corresponding storage zones 224b, 224c and 224d. According to different types or formats of data, the user can select the desired flash translation layer to store the data into the corresponding storage zone. Consequently, the performance and the lifespan of the solid state drive 220 are largely enhanced.

From the above descriptions, the solid state drive of the present invention comprises a non-volatile memory and a flash translation layer. The non-volatile memory at least comprises a first storage zone and a second storage zone. The first storage zone comprises a boot area. An operating system is stored in the boot area. After the flash translation layer receives a command and a logical block address from a host, the logical block address is converted into a physical block address by the flash translation layer. Consequently, the first storage zone is accessed according to the physical block address. Moreover, after the solid state drive receives a command and the physical block address from the host, the second storage zone is directly accessed according to the physical block address.

When the solid state drive is applied to the computer system, the solid state drive can be used to boot the computer system. When the computer system is booted, the operating system in the first storage zone and the Windows NVMe access driver and the open-channel SSD driver in the solid sate drive are loaded into the memory of the host.

After the flash translation layer receives a first command and a first logical block address from the Windows NVMe access driver, the flash translation layer converts the first logical block address into a first physical block address. Consequently, the solid state drive accesses the first storage zone according to the first physical block address.

Moreover, after the solid state drive receives a second command and a second physical block address from the open-channel SSD driver, the solid state drive accesses the second storage zone according to the second physical block address.

From the above description, the solid state drive of the present invention has the function of an open-channel solid state drive. Since the solid state drive has the booting function, the solid state drive can be applied to the Windows operating system. The host accesses a storage zone of the solid state drive through the Windows NVMe access driver. Moreover, the host accesses another storage zone of the solid state drive through the open-channel SSD driver.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A solid state drive connected with a host, the solid state drive comprising:
a non-volatile memory comprising a first storage zone and a second storage zone, wherein the first storage zone stores a first access driver for controlling the first storage zone and a second access driver for controlling the second storage zone and comprises a boot area for storing an operating system; and
a first flash translation layer receiving a first command and a first logical block address from the first access driver loaded into the host, wherein the first flash translation layer converts the first logical block address into a first physical block address, and the solid state drive accesses the first storage zone according to the first physical block address,
wherein the solid state drive receives a second command and a second physical block address from the second access driver loaded into the host, and the solid state drive accesses the second storage zone according to the second physical block address.

2. The solid state drive as claimed in claim 1, wherein the non-volatile memory further comprises a third storage zone, wherein the solid state drive receives a third command and a third physical block address from the second access driver loaded into the host, and the solid state drive accesses the third storage zone according to the third physical block address.

3. The solid state drive as claimed in claim 1, wherein the first flash translation layer further performs a garbage collection operation or a wear leveling operation on the first storage zone.

4. The solid state drive as claimed in claim 1, wherein the host further performs a garbage collection operation or a wear leveling operation on the second storage zone according to the second access driver loaded therein.

5. A computer system, comprising:
a solid state drive comprising a non-volatile memory and a first flash translation layer, wherein the non-volatile memory comprises a first storage zone, a second storage zone and a third storage zone, the first storage zone stores a first access driver for controlling the first storage zone and a second access driver for controlling the second storage zone and the third storage zone and comprises a boot area for storing an operating system, wherein the second access driver comprises a second flash translation layer and a third flash translation layer; and
a host, wherein when the computer system is booted, the operating system, the first access driver and the second access driver stored in the first storage zone are loaded into a memory of the host,
wherein after the first flash translation layer receives a first command and a first logical block address from the first access driver loaded in the host, the first flash translation layer converts the first logical block address into a first physical block address, so that the solid state drive accesses the first storage zone according to the first physical block address,
wherein after the solid state drive receives a second command and a second physical block address from the second translation layer loaded in the host, the solid state drive accesses the second storage zone according to the second physical block address,
wherein after the solid state drive receives a third command and a third physical block address from the third translation layer loaded in the host, the solid state drive accesses the third storage zone according to the third physical block address,
wherein for different types or formats of data, the second flash translation layer or the third flash translation layer is selected to store the data into the second storage zone or third storage zone.

6. (canceled)

7. The computer system as claimed in claim 5, wherein the second access driver comprises:
a translating layer receiving a request from a kernel of the host;
the second flash translation layer converting a second logical block address into the second physical block address in response to the request;
the third flash translation layer converting a third logical block address into the third physical block address in response to the request; and
an input/output layer issuing the command, the second physical block address and the third physical block address to the solid state drive, so that the solid state drive accesses the second storage zone and the third storage zone according to the second physical block address and the third physical block address,
wherein the second flash translation layer is different from the third flash translation layer.

8. The computer system as claimed in claim 5, wherein the first flash translation layer further performs a garbage collection operation or a wear leveling operation on the first storage zone.

9. (canceled)

10. The computer system as claimed in claim 5, wherein the second flash translation layer further performs a garbage collection operation or a wear leveling operation on the second storage zone.

11. The computer system as claimed in claim 2, wherein the second access driver comprises:
a second flash translation layer converting a second logical block address received from the host into the second physical block address; and
a third flash translation layer converting a third logical block address received from the host into the third physical block address,
wherein for different types or formats of data, the second flash translation layer or the third flash translation layer is selected to store the data into the second storage zone or third storage zone.

12. The computer system as claimed in claim 5, wherein the first access driver is a communication interface between a kernel of the host and the first storage zone and the second access driver is a communication interface between the kernel and the second storage zone and the third storage zone.

13. The computer system as claimed in claim 5, wherein the third flash translation layer further performs a garbage collection operation or a wear leveling operation on the third storage zone.
